(19) United States
(12) Patent Application Publication
(10) Pub. No.: US 2012/0022947 A1
(43) Pub. Date: Jan. 26, 2012

(54) ADVERTISEMENT GENERATING SYSTEM

(75) Inventor: Vaughan Thomas Esprey, West Midlands (GB)

(73) Assignee: ILLINOIS TOOL WORKS INC., Glenview, IL (US)

(21) Appl. No.: 13/158,355

(22) Filed: Jun. 10, 2011

(30) Foreign Application Priority Data
Jul. 23, 2010 (GB) GB1012391.7

(51) Int. Cl. G06Q 30/00

(52) U.S. Cl. 705/14.64; 705/14.65; 705/14.72

(57) ABSTRACT

An advertisement generating system comprises a database of advertisement templates and a controller operable to: a. access the database to correlate product related data with the advertisement template to selectively retrieve one or more advertisement templates associated with the product, b. output at least partially completed advertisement. The advertisement generating system may comprise a client device such as a point of sale or a service point device, e.g. a weighing scale.

### CROSS REFERENCE TO RELATED APPLICATION

This application claims priority to and benefit of United Kingdom Patent Application No. GB 1012391.7, entitled “ADVERTISEMENT GENERATING SYSTEM”, filed on Jul. 23, 2010, which is herein incorporated by reference in its entirety.

### BACKGROUND

The present invention relates to an advertisement generating system, more particularly to an advertisement generating system adapted for a point-of-sale or a service point apparatus such as a weighing scale.

Advertising is considered a powerful tool in stores particularly superstores which uses both information and persuasive communication to influence the human decision-making process to purchase certain products. To create the persuasive communication and to draw the attention of customers, various physical hardware devices are used to augment the information that is conveyed to the customer. These include but not limited to the use of electronically operated billboards, LCD, LED, plasma, projector and CRT displays to create flashing lights, color and/or animation that is usually thematically associated with the product.

US2003/0168260 (Muyal, Jacques) describes a weighing scale for a retail consumer product, in particular a food product, comprising a weighing member, a computing unit and two display units. The first display unit is specifically designed for the sales assistant and the second display unit is orientated towards the buyer for displaying advertisements. The computing unit in the weighing scale is equipped with specific software that allows display of animated advertisement clips on the second display unit. The second display unit is also equipped with a reproduction and broadcast device for sound messages, for example speakers incorporated in or installed on the side of the screen. Such weighing scales tend to target customers who linger around the weighing scale in order to purchase the weighed items. Similarly, EP1284475 (Premark FEG), describes a food scale for displaying frequent shopper pricing information, such as a frequent shopper total price and a frequent shopper savings amount over a normal total price during weighing of food products as well as advertising or cross marketing messages during the state when the scale is idle. The food product scale comprises a consumer display, a label printer, a user input device, a user display and a weighing mechanism. A controller connected for receiving weight signals from the weighing mechanism and input signals from the user input device is also connected for controlling information displayed by the user display and consumer display such as a LED, LCD, CRT, plasma discharge or other device. However, in both such prior art apparatus, the advertisement has to be pre-prepared prior to display on the consumer display device. In a majority of cases the generation of the advertisement material has be created manually and usually centrally such as on a store chain-wide computer and sent to the regional computers via a dedicated network system. To create the necessary persuasive effect demanded in the retail industry, sophisticated software and/or hardware are required to create the graphics or audio/animation that is not readily available to regional stores. As a result, the flexibility of generating such persuasive advertisements in any one particular regional store is severely limited without the necessary manpower, skill and software tools to create the graphic and/or animation in-house. The limited flexibility to generate advertisements at the regional level can be a burden on the store manager who in a majority of cases is totally dependent upon central office to create the appropriate advertisements. This can arise for example where the regional store has a surplus of perishable foods such as in the meat department, bakery, deli, fruit and vegetable department having a limited sell-by date. The Food Labeling Directive (2000/13/EEC) stipulates that perishable food items should be used before the displayed sell by date. Usually such goods are offered at a substantially reduced price in order to shift the goods quickly before expiry of the sell-by date otherwise the goods will be considered unfit for human consumption. Without any means to shift the surplus goods before the sell by date, this will not only lead to wastage of food products but loss of money to the vendor. To attract customers to the sale offer, the store manager has to inform the customers of the sale offer and use some sort of persuasive means such as an advertisement billboard to alert the customer. This could involve the store manager generating a poster or billboard identifying the sale items on offer that is sufficiently big and located near the check-out registers to be viewed by the customers at large. As such advertisements require time and effort to create, this would be impractical in a busy store environment since the store manager would be diverted from the more routine tasks of the smooth running of the store. Moreover, such advertisements may not draw attention to a wide customer audience due to the particular location of the advertisement billboard or may have very little persuasive effect due to the limited physical tools available to hand. The sale offer can also be announced over a tannoy system. Alternatively, a common procedure used by stores is to label the goods with different colored labels, which again does not draw attention to a wider customer audience. Many adverts that are generated locally are not as attractive to the customer as they might be, because the store staff has insufficient time or resources to make them so.

An advertisement generating system is thus required that allows adverts be generated with the minimum level of effort, skill, time and tools, which can be tailored to meet specific needs and which have the same persuasive effect in terms of attributes of the finished advertisement such as relevant, high quality graphical representation, animation, sound etc, as that created professionally.

### BRIEF DESCRIPTION

The present applicant has mitigated the above problems by providing an advertisement generating system comprising:

a. a database of product related data;

b. a controller operable to:
i. permit user input of promotional data,
ii. access the database for selection of the product related data,
iii. output the product related data and the promotional data on a background template.

Instead of the person generating the advertisement expending time and effort, an advertisement generating system of the present invention takes the burden out of manually creating the advert by automatically generating an advert based on product related data and new promotional data. Thus when new promotional data are available such as buy one, get one half price, buy one, get one free, cross promotional offers, mix-and-match, additional loyalty points or even additional reward points on certain branded credit cards, etc, the advertisement generating system of the present invention allows the store manage to widely advertise the promotion to a wider audience. In one instance, for example, when there are surplus food products that have a relatively short sell-by-date, in order to shift such products prior the expiry of the sell by date and thereby save money, the advertisement generating system of the present invention allows the store manager to selectively retrieve the product related data associated with such products on a database and interrogate the system to provide new promotional data to entice customers to purchase the products. Product related data can be inputted by a user of the system to access and select the corresponding product related data in the database, e.g. by means of a product code. Preferably, the product related data can be either input by a user input means such as a keyboard or a barcode scanner for reading the product's barcode and the controller being operable to permit user input of product related data. Alternatively or in addition to the user input means, the controller may be operable to access a database of product related data such as a stock control database. The promotional data can be either input by the user input means and the controller being operable to permit user input of promotional data. Alternatively or in addition to the user input means, the controller may be operable to access and selectively retrieve the appropriate promotional data from a database of promotional data.

On the other hand, product related data include but are not limited to product type, country of origin, weight, and price and for perishable goods such as meat or vegetables, and sell by date. The product related data can be textual or a graphical image or other media, such as video clips, or a combination thereof. The product related data and the promotional data are then output on a background template so that they can be viewed by a wide customer audience, e.g. on a display screen. The background template includes but is not limited to a corporate template displaying the corporate image. To augment the advertisement, the system may further comprise a database of media data such as graphical images or animation effects associated with the product. For example, where the product is a beef steak, the system can selectively retrieve one or more graphical images associated with the product, e.g. an image of a sirloin steak, for displaying on the background template. The media database can be a sub-database within the product related database. The media data is not limited to graphical images but can also include a sound reproduction system, such as speakers, that can be incorporated in or installed externally or on the side of the display screen or even include animation effects.

Automatically generating an advert based on simple data associated with the product such as price offer and date that has the necessary persuasive effect to attract the customer's attention without the need to create the advert manually and without the use of any sophisticated graphic/animation software, is useful in devices that are viewed by customers such as point of sale devices or even devices prior to point of sale of the product such as a service point device or a standalone display screen. A service point device generates the necessary labeling such as a barcode and/or price prior to actual sale at the point of sale device. For example, the advertisement generating system of the present invention is preferably adapted for a point of sale and/or service point device. This is to attract the attention of customers who are waiting to be served. More preferably, the point of sale and/or the service point device is a weighing scale. The point of sale or the service point device comprises a display unit, preferably a user display unit and a consumer display unit for outputting the advertisement. Optionally, the point of sale or the service point system comprises a communication port suitable for communicating with a mobile device or PDA or mobile phone. Smart mobile phone devices, e.g. iPhone®, are equipped with a high resolution display screen (LCD screen) and sound system that can be used to broadcast the advert to the owner. The communication port can communicate wirelessly with the mobile device. For example, the communication port may be adapted for communicating with the mobile devices over a short range, e.g. by means of Bluetooth.

Preferably, the controller is operable remotely from the database. More preferably the database is located in a server remote from the controller. Preferably, the controller communicates with the database over a network system. The network can be a wired or a wireless network. Further, it can be a public network, e.g., the Internet, or a private data network, e.g. a local area network (LAN) or a wide area network (WAN) or intranet. Thus, one or more point of sale or service point systems can be made to communicate with the database over the network system.

Optionally, the advertisement is built up from one or more background templates. For example, each advertisement can be built up from layers, each layer representing a portion of the advertisement. The advertisement can also include one or more promotional data by superimposing the promotional data on one or more background templates. Different combinations of the layers can be superimposed to generate the advertisement.

### DRAWINGS

Further features and aspects of the present invention will be apparent from the following detailed description of an illustrative embodiment, made with reference to the drawings, in which:

FIG. 1 is a block diagram showing the main components of the advertisement generating system according to an embodiment of the present invention,

FIG. 2 is a block diagram showing the main components of the advertisement generating system according to another embodiment of the present invention,

FIGS. 3A and 3B are an illustrative example of a weighing scale incorporating the advertisement generating system of the present invention.

FIG. 4 is a flowchart showing the procedural steps in generating an advertisement according to an embodiment of the present invention,

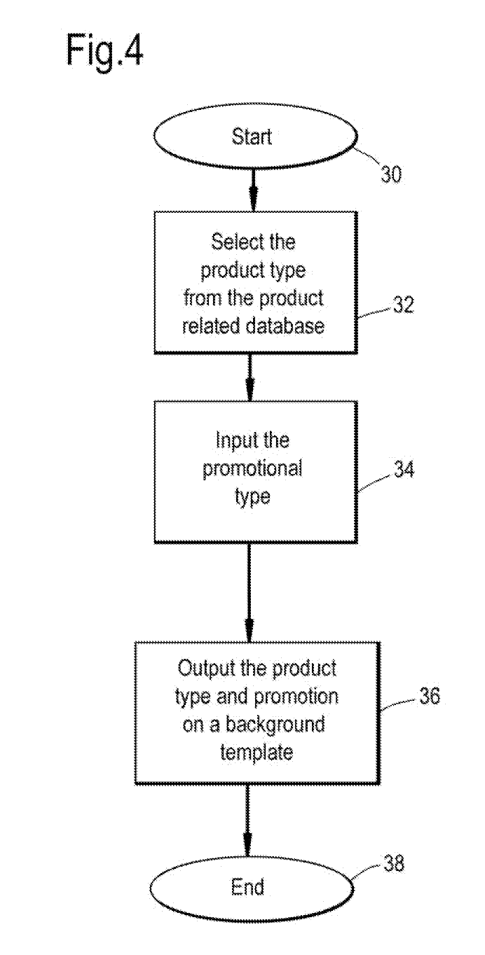

FIG. 5 is a flowchart showing the procedural steps in generating an advertisement according to another embodiment of the present invention.

### DETAILED DESCRIPTION

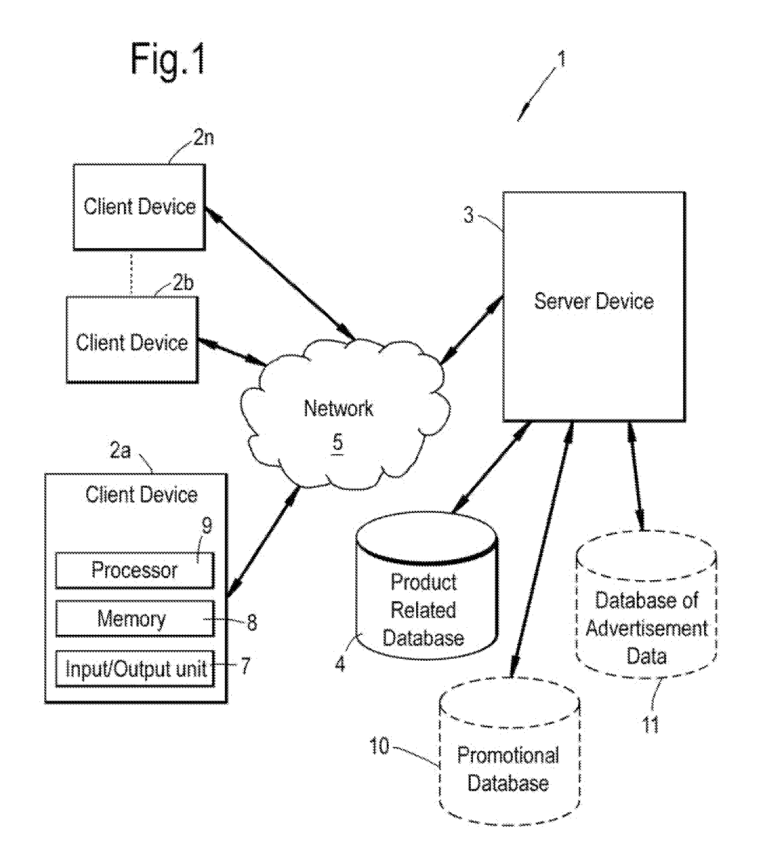

The advertisement generating system 1 shown in FIG. 1 according to an embodiment of the present invention comprises one or more client devices 2a-n in communication with a store computer or server 3 maintaining one or more databases 4 of the product related data over a network 5. Where the store is part of a chain, rather than a single store computer or server, the computer/server 3 might also be a regional computer/server or even a chain-wide computer/server.

In the particular embodiment, each of the client devices includes an input device such as a keyboard unit for inputting promotional data, a memory 8 for storing the generated advertisement templates, which can be a computer readable memory (CRM), such as a random access memory (RAM) coupled to a controller in the form of a processor 9 operable to access the database 4 for selection of the product related data and finally an output device 8 to display the promotional data and associated product related data on a background template. The product related data is read from a product related database 4 such as a stock control database and includes but is not limited to product type, country of origin, weight, and price and for perishable goods such as meat or vegetables, the sell by date. The product related data can be textual or pictorial such as a bit map. In addition to the product related data, promotional data which includes but is not limited to any one of the promotional options such as buy one, get one half price, buy one, get one free, cross promotional offers, mix-and-match, additional loyalty points or even additional reward points on certain branded credit cards, etc, can be selectively retrieved from a promotional database 10 for displaying on the background template.

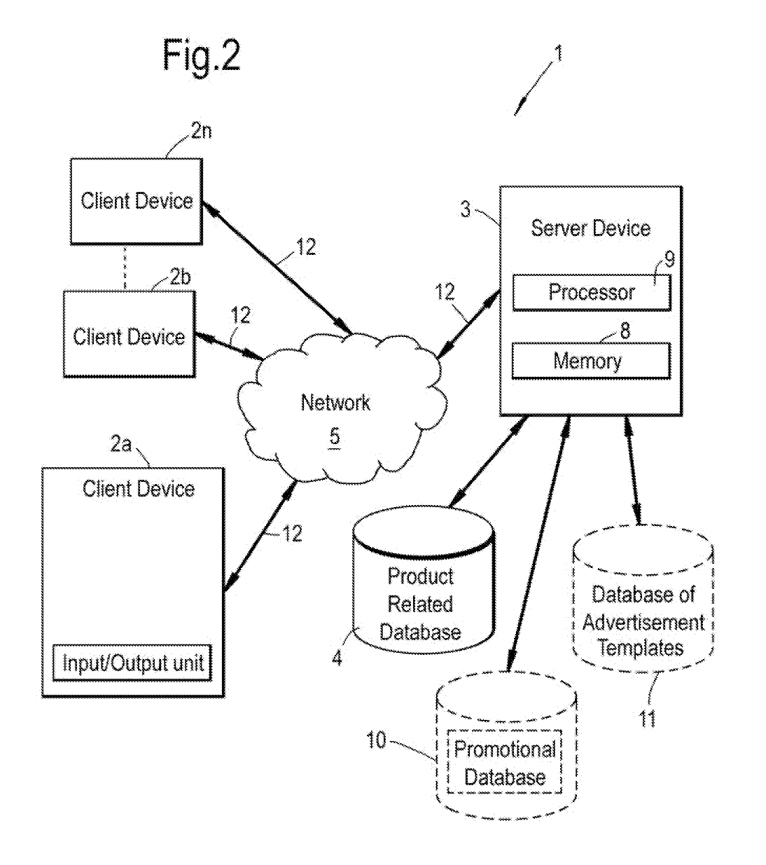

The processor 9 executes computer executable program instructions either sent to the client device centrally from the server 3 or stored in the client device, such as in memory. The processor can be any number of computer processors, such as processors from Intel Corporation. A basic advertisement can involve the controller being operable to output the promotional data and associated product related data on a background template, the background being a master template, e.g. incorporating a corporate logo. Processing of the advertisement can either be performed at the individual client devices by making reference to the product related data in the database 4 or alternatively, to simplify the client devices, the processing of the product related data can be carried out centrally at the server device 3, and the processed information sent to the client devices over the network 5 (see FIG. 2); the client devices being merely an input unit of the promotional data and an output unit for the generated advertisement. Also shown in FIG. 1 is a database of media type data or a media repository 11 which includes data to augment the advertisement such as graphical images associated with the product under promotion and/or animation effects. The promotional database 10 and the database of media data 11 are shown as dashed lines as they are not essential for performing the present invention since the promotional data can simply be inputted via the input device. Further explanation of the different variants of the system architecture is given later.

Any one of the databases 4, 10, 11 containing the product related data, promotional data and/or the media data can be located in a server which is situated in an external site remote from the client devices 2a-n. The client device 2a-n communicates with the databases 4, 10, 11 via a communication link 12 over a network system 5. The network system 5 may be a hard link or may be a wireless link such as Radio Frequency or infra red or a combination thereof. Alternatively, all of the processing operations and output of the generated advertisement may be carried out within the client device itself. The client device 2a-n may include its own database for storing any one of the product related data and/or the promotional data and/or the media data, an input/output unit and a processor for processing the product related data to generate an advertisement. For example, the client device may be a standard computer, a weighing scale, or any device capable of processing information comprising at least one computer readable medium containing the database of product related data, media data and one or more background templates. The medium can be of any suitable type, e.g. magnetic, optical or solid state memory. It may be fixed in the controller or server or removable, e.g. as optical or magnetic disk or flash drive.

The advertisement generating system can be incorporated into a point of sale device. Alternatively, the advertisement generating system can form part of a service point device whereby the items or goods for sale are prepared prior to sale at the point of sale device such as weighing and labeling (e.g. barcode), packaging and/or pricing.

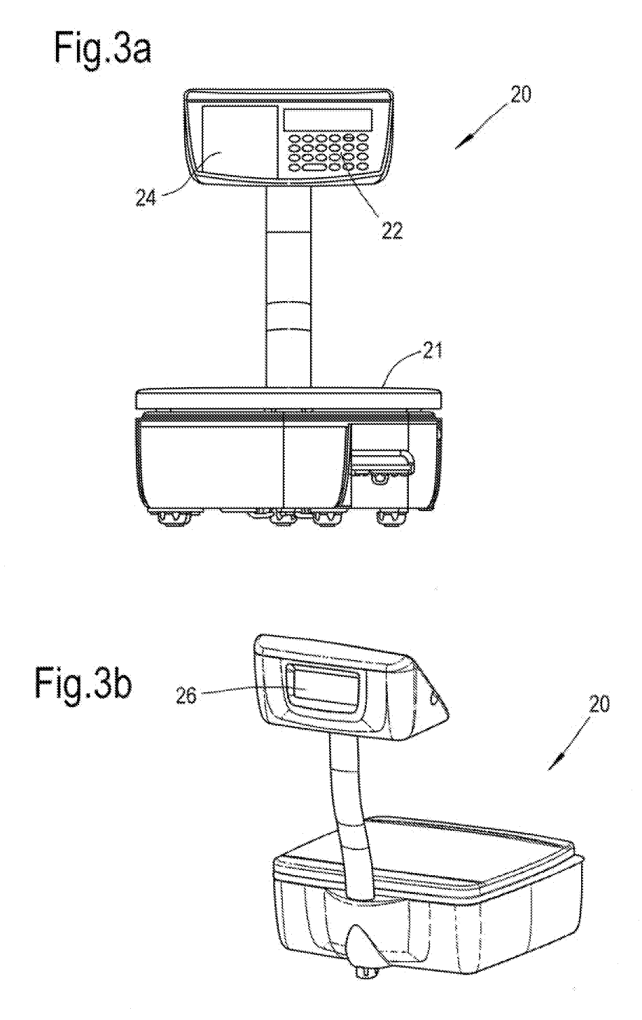

To better explain the operation and advantages of the advertisement generating system of the present invention, the client device will be described with reference to a weighing scale 20 typically used in grocery stores, supermarkets or butchers' shops as shown in FIGS. 3(a and b). However, the client device of the present invention is not restricted to a weighing scale and the client device can be any device suitable to output advertisement material. Referring to FIGS. 3(a and b), the weighing scale 20 comprises a weighing platform 21, an input device 22 in the form of a keyboard for inputting product related data, an operator/user display 24 and a consumer display 26. Alternatively, the weighing scale 20 can dispense with the consumer display and comprise an operator display 24 so that the advertisement is only made available to the operator. Equally, the display unit can be rotatably mounted such that it can swivel to face either the operator or the consumer. Promotional data can also be inputted via a touch screen display incorporated in the user display 24. For example, the operator display 24 can allow the operator to navigate through a range of product types in the product related database and to select one or more products that is/are on special offer. Typically, a menu is presented to the operator having one or more layers, each layer representing a particular product category or sub-category such as fruits, vegetables, meats etc. In use, the controller accesses the product related database which can be the stock control database and provides the operator with a menu to permit selection of the particular product under promotion and to manually interrogate the system to input the promotional details such as price discounts or extras as discussed above. For example, the system can be tailored to provide the user to select the promotional type. Alternatively, the product can be identified from its associated barcode being read by a barcode scanner incorporated in the input device which in turn triggers the controller to access the product related database to retrieve the associated product related information for display to the user. Equally, the promotional data can be sent from an external or internal computer or server over the network system maintaining one or more databases, e.g. from a regional wide or even chain wide computer system as discussed above, i.e. centrally at head office. In one scenario, surplus perishable goods in any one store having a sell-by date that is due to expire shortly may be flagged up by a stock control system coupled to the weighing scale, which sends a message to the weighing scale. In order to shift the goods quickly before expiry of the sell-by date, the advertisement generating system issues promotional offers such as price discounts or optional extras in the form of a generated advert. These could be standardized offers depending upon the expiry of the sell-by date or alternatively could be manually input by the operator or store manager. Further detail of the different ways by which the advertisement generating system of the present can be used to generate adverts is explained later. Further processing can include, calculating the saving offered to the customer as result of the promotion. For example, the controller can be operable to calculate the difference between the standard price and the promotional price.

In order for the customers to be made aware of the product offer and to provide the necessary persuasive effect to alert the customer of the offer, the advertisement generating system of the present invention generates an advert to be shown on the consumer display of the weighing scale. This is so to attract the attention of customers who are waiting to be served the weighed goods in the case of a weighing scale, or who are waiting at a till in the case of a checkout. To maximize the awareness of the product offering and in combination with the consumer display of the weighing scale, the system can also be made to send a signal to cause additional display screens (not shown) such as LCD screens located elsewhere in the store, e.g. near the check-out register or near the goods concerned to broadcast the advert. With the increasing use of smart phones and similar personal electronic devices incorporating high resolution LCD screens and a sound reproduction capability, the system can also wirelessly communicate via a communication port to personal mobile devices when they are in the vicinity of the weighing scale, e.g. by means of Bluetooth®. Such “push” type advertisements will alert the customer of the product offering when they approach the weighing scale or any device incorporating the communication port for wirelessly broadcasting the advert. Alternatively or in addition to displaying the advert on a consumer display, the system can comprise a printer for printing the advert on a label or purchase receipt.

With regards to the generation of the advertisement for broadcasting to the customers, the system starts 30 by selecting 32 the appropriate product under promotion. This could be done by the user or operator searching the product stored in the product related database 4, and then manually inputting the promotion 34. For example, in one embodiment, the product details in the product related database 4 such as type of product and classification of product, (i.e. fruit, vegetable, meat etc,), its standard price, sell by date, country of origin, etc, can be presented to the user as a page and the user navigates through the various pages to find a particular product. Each page has a promotional option whereby once selected the user or operator can input or choose 34 an appropriate promotion to be displayed. Alternatively and as discussed above, the product details can be retrieved from the product related database 4 using a code associated with the product such as a barcode and the user then enters the promotional details. The product type and the promotion are then automatically displayed on a background template or a corporate background template 36. The system can also display the saving as a result of the promotion by referring to the standard price in the product related database. The automatically generated adverts are then displayed on the output device (steps 36). The latter is particularly advantageous during the idle time of the weighing scale, i.e. when the scale is not being used for its primary purpose of trading and is free to play adverts, in the hope of attracting the attention of passing customers. Alternatively or in addition to playing the adverts during the idle time of the weighing scale, the system can be set up to generate an advertisement after the detection of equivalent products being input via the client device (e.g. weighing scale) either through the keyboard or scanner. For example, if equivalent or alternative products are available, e.g. at a reduced price but having a shorter sell-by date, the system can alert the customer and/or vendor and/or operator via a generated advertisement.

Instead of manually selecting product data from the product related database that are to be promoted which in a majority of cases are associated with products that are close to their sell by date or have surplus stock, the system can automatically retrieve all those products that fall within a predetermined sell by date or fall within a predetermined surplus stock and the user can either manually input the promotion associated with those products in order to shift the stock or alternatively, the controller can automatically select a promotion based on a predetermined set of rules, which could be standardized for all product types, e.g. maximizing profit to the vendor. For example, buy one get one half price provides a bigger profit margin than buy one get one free. Each promotion has a different degree of effect in enticing the customers to purchase the product. Those having a greater effect, offer the most benefits to the customers. This could be used, on occasion, where a number of promotional types have been exhausted and in order to shift the products quickly as the expiry of the sell by date approaches, one or more attractive promotional types need to be used. The attractiveness of the promotional type could be timed and may depend upon the time scale from the sell by date. For example, the length of time from the sell by date can be broken into predetermined time scales whereby when each time scale has past, it triggers a different promotional type to be used in order to entice the customer to purchase the product. As the time approaches the sell-by-date, the system can trigger promotions that offer more benefits to the customer, e.g. in monetary terms or loyalty points, in order to better persuade the customer to purchase the product.

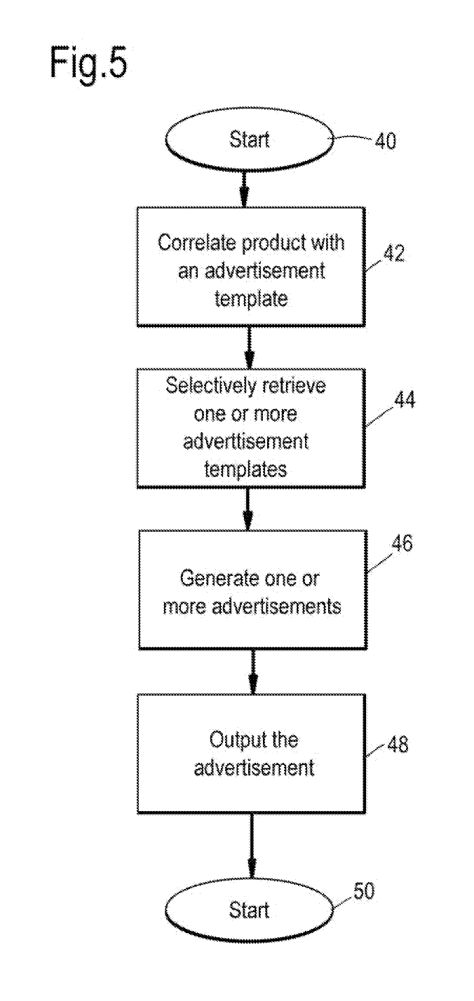

To augment the advertisement and in conjunction to the background template, the system can also display media data such as various graphical images or endorsement clips or even play animation stored in an media database or media repository 11 associated with the product under offer on the background template. The media database 11 could be a sub-database within the product related database 4. The system starts 40, (see FIGS. 5) by correlating the product related data with the media data stored as data files in the database so as to selectively retrieve one or more media data files associated with the product (42, 44 in FIG. 5). From the selected media data, the system then generates the advertisement (step 46 in FIG. 5), e.g. by importing the media data on the background template. Processing of the advertisement can either be carried out in the client device by making reference to the database or remotely via a central server and the generated adverts “pushed” to the client devices over the network. In the case of a weighing scale described above, all or some of the processing of the advertisement can either be carried out in the weighing scale via a built-in processor or remotely via a central server. Moreover, at least some or all of the product related data and/or promotional data including media data contained in their respective databases can either be accessed locally by incorporating a computer readable medium in the weighing scale such as a magnetic, optical, or solid state memory or remotely via an external server. Correlation of the product related data with the media data files in the media database 11 (see FIGS. 1 and 2) can involve identifying one or more keywords or search terms in the product related data and locating one or more media data files sharing the same keyword or term or category. In one embodiment of the present invention, the media data files can be categorized into classifications, a higher order classification to categorize the family of products, e.g. fruits, vegetables, meats etc, and one or more lower order classification terms, e.g. the type and cut of the meat etc. A further classification can be present to categorize the theme of the advertisement. One or more search terms or classification terms can be used to selectively retrieve the media data from the database. The product types are pre-assigned into classification terms (usually by human intervention) and stored in the memory 8 which can be located in the client device or the server. The system can use the pre-assigned classification terms to retrieve one or more media templates from the database. For example, beef type products are categorized under the high order classification, cow and thus, the system can selectively retrieve one or more media templates under this category, e.g. a picture of a cow. Each data file is pre-assigned both higher order and lower order classification terms.

Once the controller has identified one or more media data files appropriate to the product related data, it selectively retrieves these media data for broadcasting on the output device 38. The choice of the media data for broadcasting can be made automatically by means of a predetermined set of rules associated with the product type. Alternatively, the product related database 4 is linked to the media database 11 so as to present a range of media type data associated with the product type for selection by the operator. The media data files can be retrieved either locally at the client device or remotely, e.g. at head office.

The advertisement can be built up from one or more media data types or layers, each media data type can represent a particular theme to be portrayed by the advertisement. Several layers can be superimposed on the background template to form the advertisement. The choice and ordering of the layers will depend upon numerous factors associated with the advertisement such as the theme to be portrayed, e.g. seasonal effects, and the product type. For example, the meat product, e.g. lamb, can be classed with a season, e.g. Spring, and media data file(s) will be selectively retrieved associated with this season. The controller may also utilize ‘fuzzy logic’ to gauge and learn the effects of the different combinations of the media data, e.g. by means of the sale revenue generated. The media data may not only include still graphic images but also animation effects to augment the background template so as to enhance the persuasiveness of the advertisement. Further effects can be used to further augment the advertisement such as sound effects. The output device can incorporate one or more sound reproduction systems to deliver the sound effects.

The advertisement generating system of the present invention can also personalize the advert to the individual customers depending on their purchasing habits by means of sending the advert to their mobile device such as their PDA or mobile phone as discussed above. For example, individual purchase habits can be obtained from the customer's store loyalty card and using such data to provide promotional offer or even attach e-coupons (electronic coupons) to the generated advertisement selected from the database.

1. An advertisement generating system, comprising:
a product related database of product related data, and
a controller operable to permit user input of promotional data, access the database for selection of the product related data, and output the product related data and the promotional data on a background template.

2. The system of claim 1, comprising a promotional database of promotional data, wherein the controller is configured to enable selection of the promotional data.

3. The system of claim 1, wherein the controller is configured to enable user selection of the product related data.

4. The system of claim 1, comprising a media database of media data, wherein the controller is configured to access the media database to correlate product related data with the media data to selectively retrieve one or more media data associated with a product, and the controller is configured to output the one or more media data on the background template.

5. The system of claim 4, wherein the advertisement generating system is configured to enable user selection of the media data.

6. The system of claim 1, wherein the advertisement generating system is configured for a point of sale system or a point of serve system.

7. The system of claim 6, wherein the point of sale system or the point of serve system is a weighing scale.

8. The system of claim 6, wherein the point of sale system or the point of serve system comprises a label printer configured to output the advertisement.

9. The system of claim 6, wherein the point of sale system or the point of serve system comprises a display unit configured to output the advertisement.

10. The system of claim 9, wherein the display unit is remote from the point of sale system or the point of serve system.

11. The system of claim 6, wherein the point of sale system or the point of serve system comprises a communication port configured to enable wireless communication with a mobile device.

12. The system of claim 11, wherein the communication port is configured to enable the wireless communication by Bluetooth.

13. The system of claim 6, wherein the point of sale system or the point of serve system comprises a sound reproduction means.

14. The system of claim 1, wherein the controller is operable remotely from the product related database, a promotional database of promotional data, and/or a media database of media data.

15. The system of claim 14, wherein the product related database and/or the promotional database and/or the media database is/are located in a server, wherein the controller is configured to communicate with the product related database and/or the promotional database and/or the media database over a network system.

16. A method of generating an advertisement, comprising:
retrieving product related data from a product related database of an advertisement generating system;
enabling input of promotional data from a user input; and
outputting the product related data and the promotional data on a background template.

17. The method of claim 16, wherein enabling input comprises enabling selection of the promotional data from a promotional database of the advertisement generating system.

18. The method of claim 17, comprising enabling selection of the product related data from the product related database.

19. The method of claim 18, comprising correlating and retrieving one or more media data associated with a product from a media database, and outputting one or more of the media data on the background template.

20. The method of claim 19, wherein correlating comprises assigning one or more classification terms to the media data in the product related database.
